(19) United States
(12) Patent Application Publication
(10) Pub. No.: US 2024/0248432 A1
(43) Pub. Date: Jul. 25, 2024

(54) HAIRSPRING FOR A TIMEPIECE MOVEMENT

(71) Applicant: ROLEX SA, Geneva (CH)

(72) Inventor: Pierre Villaret, Villy-le-Pelloux (FR)

(73) Assignee: ROLEX SA, Geneva (CH)

(21) Appl. No.: 18/419,217

(22) Filed: Jan. 22, 2024

(30) Foreign Application Priority Data
Jan. 25, 2023 (EP) 23153324.1

(51) Int. Cl. G04B 17/32; G04B 17/06

(52) U.S. Cl. CPC G04B 17/325; G04B 17/063

(57) ABSTRACT

The hairspring (1; 1′) has a spring blade (11; 11′) and a connecting member (12; 12′) for fastening the hairspring (1; 1′) to a frame (5, 6, 8), the connecting member including first (13a; 13a′) and second (13b; 13b′) fastening element, a first arm (121; 121′) connecting the first fastening element (13a; 13a′) to the second fastening element (13b; 13b′), and a second arm (122; 122′) connecting the first arm (121; 121′) to the spring blade (11; 11′), the second arm (122; 122′) being connected to the spring blade (11; 11′) in a first joining zone (122a; 122a′), the hairspring (1; 1′) being configured or arranged so that a first displacement of a first amplitude of the first fastening element (13a; 13a′) relative to the second fastening element (13b; 13b′) does not cause any displacement of the second arm (122; 122′), particularly of the first joining zone (122a; 122a′), or causes a second displacement of a second amplitude of the second arm (122; 122′), particularly of the first joining zone (122a; 122a′), relative to the second fastening element (13b; 13b′), the second amplitude being less than 0.15 times or 0.1 times or 0.05 times the first amplitude.

### CROSS-REFERENCE TO RELATED APPLICATION

This application claims priority of European patent application No. EP23153324.1 filed Jan. 25, 2023, the content of which is hereby incorporated by reference herein in its entirety.

### BACKGROUND ART

The invention relates to a hairspring for a timepiece movement. The invention also relates to an assembly, particularly a timepiece movement, comprising such a hairspring. Finally, the invention relates to a timepiece comprising such a hairspring or such an assembly.

EP2437126 discloses various hairsprings that are each provided with a connecting member. Depending on the variant under consideration, the connecting member can be in the shape of a portion of a circle or a circle, or have a straight shape. This connecting member takes the form of a single element, which is not intended to be actuated by play adjustment elements.

JP2016173241 relates to a device for attaching a hairspring, further acting as a damping device intended to protect the coils from shocks. To this end, the hairspring comprises a connecting member consisting of two portions with different resilience, it being possible for these portions to be delimited by the positioning of the outer end of the coils of the hairspring. This connecting member takes the form of a single element, which is not intended to be actuated by play adjustment elements.

EP3032354 relates to a device for rotating a hairspring with respect to a fastening support, which is configured so that the operation to put the timepiece in beat can be performed directly by rotating the hairspring, and not by rotating the fastening support. The hairspring comprises a connecting member. Screwing a balance bridge to the plate screws results in the rigid connection of the outer end of the hairspring to the frame of the movement, particularly due to the connecting member being clamped between the plate and the balance bridge. However, this connecting member is not intended to be actuated by play adjustment elements.

### SUMMARY OF THE INVENTION

The aim of the invention is to provide a hairspring that makes it possible to improve the hairsprings known in the prior art. The invention particularly proposes a hairspring specially configured to be actuated by play adjustment elements. This hairspring configuration particularly avoids any risk of deformation of the blade of the spring during the handling of axial play adjustment elements.

A hairspring according to the invention is defined in point 1 below.
1. A hairspring comprising a spring blade and a connecting member for fastening the hairspring to a frame, the connecting member comprising:
   a first fastening element,
   a second fastening element,
   a first arm connecting the first fastening element to the second fastening element, and
   a second arm connecting the first arm to the spring blade, the second arm being connected to the spring blade in a first joining zone, the hairspring being configured or arranged so that a first displacement of a first amplitude of the first fastening element relative to the second fastening element does not cause any displacement of the second arm, particularly of the first joining zone, or causes a second displacement of a second amplitude of the second arm, particularly of the first joining zone, relative to the second fastening element, the second amplitude being less than 0.15 times or 0.1 times or 0.05 times the first amplitude.

Embodiments of a hairspring according to the invention are defined in dependent points 2 to 6 below.
2. The hairspring as defined in point 1, wherein the first amplitude and the second amplitude are measured perpendicular to:
   a first plane in which the spring blade extends, and/or
   a second plane in which the connecting member extends.
3. The hairspring as defined in point 1 or 2, wherein the ratio of the length of the first arm to the length of the second arm is between 2 and 10 or between 3 and 8.
4. The hairspring as defined in one of the preceding points, wherein a second joining zone for joining the first arm to the second arm is located at a point or boundary such that the ratio of:
   the distance separating this point or boundary from the first fastening element to
   the distance separating this point or boundary from the second fastening element is greater than 4 or greater than 8.
5. The hairspring as defined in one of the preceding points, wherein the hairspring is a single piece or integrally formed.
6. The hairspring as defined in one of the preceding points, wherein the hairspring is partially or fully made from:
   single-crystal silicon whatever its orientation, or
   polycrystalline silicon, or
   amorphous silicon, or
   amorphous silicon dioxide, or
   doped silicon whatever the type and level of doping, or
   porous silicon, or
   silicon carbide, or
   glass, or
   ceramic, or
   quartz, or
   metal, or
   a metal alloy, particularly an Nb—Zr alloy.

An assembly according to the invention is defined in point 7 below.
7. An assembly, particularly a timepiece movement, comprising an oscillator comprising a hairspring as defined in one of the preceding points, in particular an oscillator comprising a balance and a hairspring as defined in one of the preceding points mounted on a staff, and an assembly device, the assembly device comprising:
   a first blank for pivoting the oscillator, and
   a second blank for pivoting the oscillator.

Embodiments of an assembly according to the invention are defined in dependent points 8 to 14 below.
8. The assembly as defined in the preceding point, wherein the assembly device comprises a first element for positioning the first blank relative to the second blank, particularly a screw foot, the first positioning element being arranged and/or configured so as to position the hairspring relative to the first blank and/or relative to the second blank, in a plane of the assembly.
9. The assembly as defined in point 7 or 8, wherein the assembly device comprises a first axial play adjustment element and a second axial play adjustment element, the first axial play adjustment element interacting with the second axial play adjustment element to adjust the axial play of the oscillator by moving the first fastening element relative to the first blank for pivoting the oscillator, and/or the second 10 blank for pivoting the oscillator.
10. The assembly as defined in the preceding point, wherein the first axial play adjustment element comprises a nut and the second axial play adjustment element comprises a thread made on a first element for positioning the first blank relative to the second blank, particularly made on a screw foot.
11. The assembly as defined in one of points 7 to 10, wherein the first blank and the second blank are arranged and/or configured to hold the hairspring between them, particularly to hold the hairspring and a third blank between them.
12. The assembly as defined in one of points 7 to 11, wherein the second arm is held, in particular held interposed or clamped between:
   the first blank, and
   the second blank or a retaining element, or between:
   the second blank, and
   a retaining element.
13. The assembly as defined in one of points 7 to 12, wherein the second joining zone for joining the first arm to the second arm is held, in particular held interposed or clamped, between the first blank and the second blank.
14. The assembly as defined in one of points 7 to 13, wherein:
   the first blank is a balance bridge, and/or
   the second blank is a plate.

A timepiece according to the invention is defined in point 15 below.
15. A timepiece, in particular a wristwatch, comprising a hairspring as defined in one of points 1 to 6 and/or an assembly as defined in one of points 7 to 14.

### BRIEF DESCRIPTION OF THE DRAWINGS

The appended drawings show, by way of example, two embodiments of a timepiece according to the invention.

FIG. 1 is a schematic view of first embodiment of a timepiece according to the invention.

FIG. 2 is a similar view, with the balance bridge removed.

FIG. 3 is a partial cross-sectional view of the first embodiment, along the plane IV-IV in FIG. 1.

FIG. 4 is a partial cross-sectional detail view of the first embodiment along the plane IV-IV in FIG. 1, in line with an element for the relative positioning of blanks.

FIG. 5 is a partial view of the first embodiment in line with an element for the relative positioning of the blanks.

FIG. 6 is a partial detail view of a second embodiment of a timepiece according to the invention.

### DETAILED DESCRIPTION OF PARTICULAR EMBODIMENTS

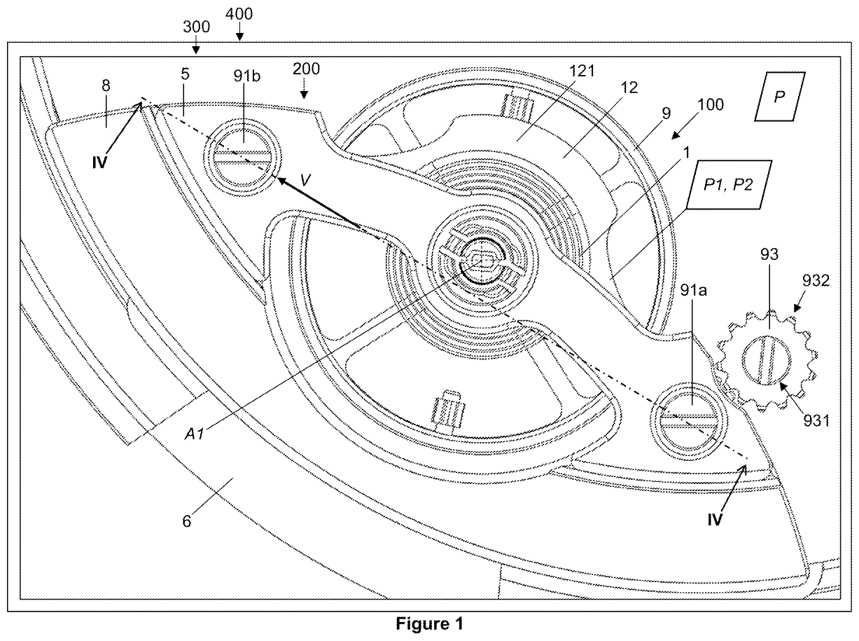

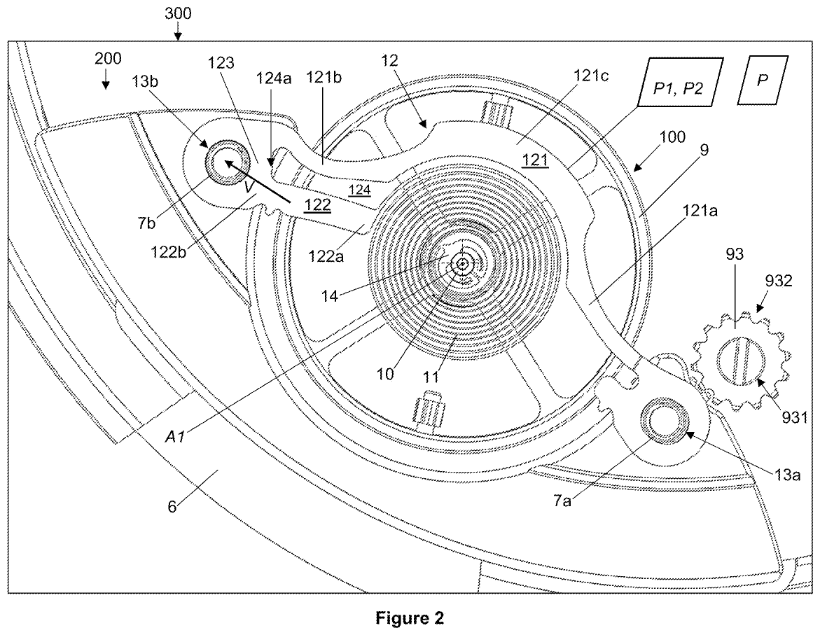

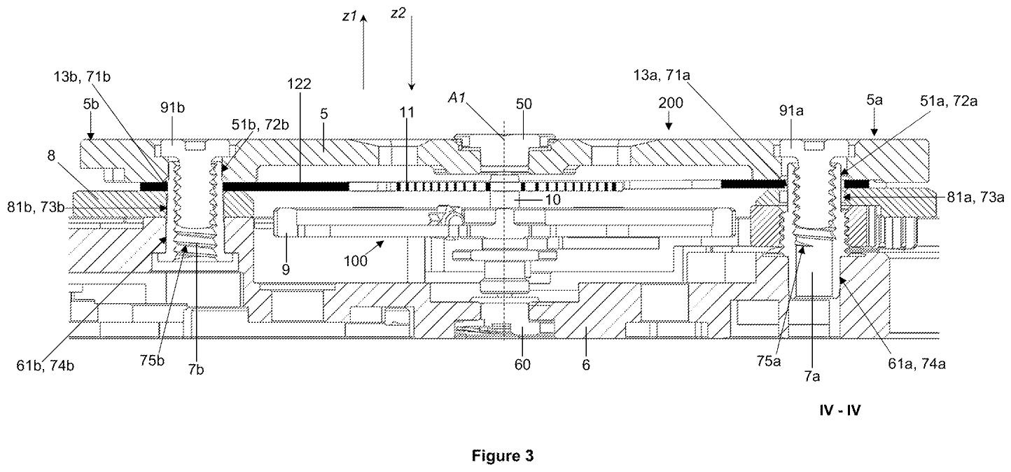

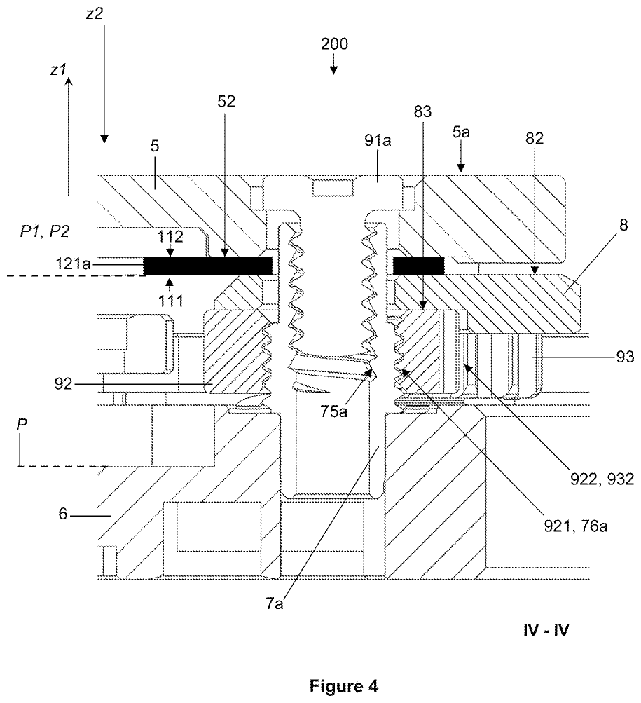

A first embodiment of a timepiece 400 is described in detail hereinafter with reference to FIGS. 1 to 5.

The timepiece 400 is for example a watch, particularly a wristwatch. The timepiece 400 comprises an assembly or a timepiece movement 300 suitable for being mounted in a timepiece case in order to protect it from the external environment.

The timepiece movement 300 can be a mechanical movement, in particular an automatic movement, or a hybrid movement.

The timepiece movement 300 or assembly 300 comprises:
an oscillator 100 comprising a hairspring 1, in particular an oscillator 100 comprising a balance 9 and a hairspring 1 mounted on a staff 10, and
an assembly device 200 comprising:
a first blank 5 for pivoting the oscillator 100, and
a second blank 6 for pivoting the oscillator 100.

The first blank 5 and the second blank 6 form part of a frame of the assembly or movement. The frame can further comprise a bridge 8 for protecting the balance 9.

The hairspring 1 comprises:
a spring blade 11, and
a connecting member 12 for fastening the hairspring 1 to the blanks 5, 6, 8 of the frame.

The connecting member 12 comprises:
a first fastening element 13a,
a second fastening element 13b,
a first arm 121 connecting the first fastening element 13a to the second fastening element 13b, and
a second arm 122 connecting the first arm 121 to the spring blade 11, said second arm 122 being connected to the spring blade 11 in a first joining zone 122a.

The hairspring 1 is configured and/or arranged so that a first displacement (axial, parallel to the axis A1 or perpendicular to the plane P1 or the plane P2) of a first amplitude of the first fastening element 13a relative to the second fastening element 13b does not cause any displacement of the second arm 122, particularly of the first joining zone 122a, or causes a second displacement of a second amplitude of the second arm 122, particularly of the first joining zone 122a, relative to the second fastening element 13b, the second amplitude being less than 0.15 times or 0.1 times or 0.05 times the first amplitude.

As mentioned above, the hairspring 1 is remarkable in that the connecting member 12 has two separate arms 121, 122. The first and second arms each have a substantially greater stiffness than the blade 11 of the hairspring. A first portion 121a of the first arm 121 is capable of being moved in a vertical or substantially vertical direction, that is, a direction perpendicular or substantially perpendicular to:
a first plane P1 in which the spring blade 11 extends, and/or
a second plane P2 in which the connecting member 12 extends, and/or
a third plane P in which the timepiece movement 300 extends.

As a result, the first amplitude and the second amplitude mentioned above are measured perpendicular to the:
first plane P1 in which the spring blade 11 extends, and/or
second plane P2 in which the connecting member 12 extends, and/or
third plane P in which the timepiece movement 300 extends.

This displacement can be caused by axial play adjustment elements.

The second arm 122 is non-movable or can be moved very little and connects the outer end of the blade 11 of said hairspring to a second portion 121b of the first arm 121.

The hairspring 1 is intended to be incorporated into the assembly device 200. This assembly device is intended to restrain at least the second arm 122, particularly downstream of a joining zone 123 for joining the second arm 122 to the second portion 121b of the first arm 121. The axial play adjustment elements mentioned above and capable of acting on the first portion 121a of the first arm 121 form part of the assembly device 200.

The elements 11 and 121, 122 of the hairspring 1 respectively extend in the planes P1 and P2, which are preferably parallel or substantially parallel to the plane P in which the movement 300 extends. The vertical directions, denoted z1 for a first orientation and z2 for a second orientation (opposite to the first orientation), are perpendicular to the planes P, P1, and P2.

Such an assembly device 200 has the advantage of permitting the displacement of the first portion 121a of the first arm 121 in the vertical or substantially vertical direction, without generating the displacement and/or deformation of the second arm 122, and therefore of the blade 11. The chronometric performance is thus independent of the play adjustment of the oscillator.

Advantageously, in the assembly device 200, the connecting member 12 is positioned and fixed in the plane P relative to the first blank 5, for example a balance bridge 5, and to the second blank 6, for example a plate 6 of the movement 300. The connecting member 12 is particularly positioned and fixed in the plane P between the first and second blanks 5 and 6.

The balance-hairspring assembly 100, particularly the staff 10 of the balance-hairspring 100, is pivoted here by respective bearings 50 and 60 of the balance bridge 5 and the plate 6. The axial play adjustment elements are intended to move the bearing 50 relative to the bearing 60 in the vertical direction via the displacement of the first blank 5 relative to the second blank 6, particularly via the displacement in the vertical direction or a direction substantially parallel to this direction of a first portion 5a of the balance bridge relative to a second portion 5b of the balance bridge fixed relative to the plate 6. The first and second portions 5a, 5b can for example form the longitudinal ends 5a, 5b of a balance bridge 5, as shown in FIG. 1. The balance bridge 5 is a through-component as illustrated in FIG. 1, that is, it is fastened to the second blank 6 on either side of the balance 9. Preferably, the axes of the fastenings of the balance bridge 5 are positioned at an angle of approximately 180° relative to the axis A1 of the balance-hairspring assembly 100, particularly of the staff 10. This angle can for example be between 130° and 180°. In FIG. 1, the angle is approximately 165°.

The first arm 121 of the connecting member 12 of the hairspring 1 illustrated in FIGS. 1 to 5 is provided with:
a central portion 121c in the shape of a portion of a ring the angular extent of which is of the order of 100° with respect to the axis A1 of the balance-hairspring assembly 100, particularly of the staff 10, and
portions 121a and 121b, which are elbowed here and are positioned on either side of the central portion 121c.

The portions 121a and 121b each comprise, at one of their respective ends, an element 13a, 13b for fastening and positioning the hairspring with respect to the first blank 5 and the second blank 6, which is described in detail hereinafter.

The second arm 122 has a straight or substantially straight shape that is oriented radially or substantially radially relative to the axis A1. A first end 122a of the arm 122 adjoins the blade 11 of the hairspring and forms a joining zone 122a for joining the connecting member 12 to the blade 11, while a second end 122b of the arm 122 adjoins the second portion 121b of the first arm 121 and forms a joining zone 123 for joining the second arm 122 to the first arm 121. In this first embodiment, the joining zone 123 for joining the second arm 122 to the first arm 121 is located in line with the fastening and positioning element 13b. As a results, a slot 124, oriented radially or substantially radially relative to the axis A1, can separate the arms 121 and 122, particularly the second portion 121b and the second arm 122.

The fastening and positioning elements 13a, 13b here take the form of openings, particularly through-openings, that are intended to interact respectively with positioning elements 7a, 8b, also intended to make it possible to position (and fasten) the first blank 5 relative to the second blank 6 in the plane P.

Here, each positioning element 7a, 7b takes the form of a screw foot driven respectively into an opening 61a, 61b of the second blank 6, particularly in a respective driving portion 74a, 74b of each positioning element 7a, 7b.

When the balance-hairspring assembly 100 is mounted in the movement 300, the screw feet 7a, 8b are intended to be housed in the respective openings 13a, 13b. To this end, each screw foot 7a, 7b more particularly comprises a guide portion 71a, 71b that is intended to position the outer end of the hairspring 1 precisely, particularly the connecting member 12, with respect to the balance bridge 5 and the plate 6.

Advantageously, the geometry of the guide portions 71a, 71b corresponds to the geometry of the openings 13a, 13b, aside from the assembly clearance. Preferably, the guide portions 71a, 71b are cylindrical or at least partially cylindrical. Preferably, the opening 13b is circular, while the opening 13a is oblong, in particular in a direction oriented toward the center of the opening 13b, in order to overcome any risk of hyperstaticity during the assembly of the balance-hairspring assembly 100 and/or to allow the displacement of the opening 13a in a substantially vertical direction with respect to the screw foot 7a.

The first blank 5 also comprises through-openings 51a, 51b intended to receive the screw feet 7a, 7b, which are located respectively in the portions 5a, 5b of the first blank 5. Each screw foot 7a, 7b more particularly comprises a guide portion 72a, 72b that is intended to position the first blank 5 precisely in the plane P by means of the respective openings 51a, 51b. The opening 51a can also be oblong, in particular oriented toward the center of the opening 51b, in order to overcome any risk of hyperstaticity during the assembly of the balance-hairspring assembly 100 or to allow the displacement of the portion 5a in a substantially vertical direction with respect to the screw foot 7a.

The assembly device 200 can optionally also comprise a bridge 8 for protecting the balance 9. This bridge is arranged (at least partially) on the plate 6. Advantageously, it is also positioned with respect to the plate 6 in the plane P by means of the screw feet 7a, 7b. To this end, the bridge 8 comprises through-openings 81a, 81b intended to receive the screw feet 7a, 7b in the guide portions 73a, 73b of the balance-protecting bridge 8. The opening 81a can also be oblong, in particular oriented toward the center of the opening 81b, in order to overcome any risk of hyperstaticity during the assembly of the balance-hairspring assembly 100 or to allow the displacement of opening 81a in a substantially vertical direction with respect to the screw foot 7a. The assembly can thus comprise a third blank 8, the third blank being for example a balance-protecting bridge 8 and/or the third blank being for example interposed or arranged between the first and second blanks 5, 6.

Once the device 200 has been assembled, the connecting member 12 of the hairspring is positioned between the first blank 5, typically the balance bridge 5, and the second blank 6, typically the plate 6. For example, more specifically, the connecting member 12 of the hairspring can be positioned between the balance bridge 5 and the balance-protecting bridge 8. In particular, the upper surface 112 of the hairspring 1, more specifically of the connecting member 12, is in contact against a lower bearing surface 52 of the balance bridge 5, and the lower surface 111 of the hairspring 1, more specifically of the connecting member 12, is bearing against an upper bearing surface 82 of the balance-protecting bridge 8. The hairspring 1, particularly the connecting member 12, is thus clamped between the first blank 5 and the second blank 6. In particular, the second joining zone 123 for joining the first arm 121 to the second arm 122 is held, in particular held interposed or clamped, between the first blank 5 and the second blank 6.

The balance-hairspring assembly 100, particularly the hairspring 1, is fastened to the movement 300 when the balance bridge 5 is fastened to the plate 6 by means of screws 91a, 91b intended to be screwed into respective tapped holes 75a, 75b of the screw feet 7a, 7b. The hairspring 1, particularly the connecting member 12, is thus positioned and clamped between the first blank 5 and the second blank 6.

Each screw foot 7a, 7b therefore combines various functions and thus comprises:
a first portion 71a, 71b for guiding the hairspring 1;
a second portion 72a, 72b for guiding the balance bridge 5;
a third portion 73a, 73b for guiding the balance-protecting bridge 8;
a portion 74a, 74b for driving into the plate 6; and
a tapped hole 75a, 75b intended to receive a screw 91a, 91b.

These guide portions are preferably cylindrical or at least partially cylindrical. Advantageously, the diameter of the second guide portion 72a, 72b is smaller than the diameter of the first guide portion 71a, 71b. Advantageously, the diameter of the first guide portion 71a, 71b is smaller than the diameter of the third guide portion 73a, 73b.

In this embodiment of the assembly device 200, the axial play adjustment elements are arranged in the first portion 5a of the balance bridge 5. The axial play adjustment elements comprise:
a first adjustment element 92 comprising a nut 92 including a tapped portion 921, and
a second adjustment element 76a comprising a threaded portion 76a of the screw foot 7a,
the first and second elements interacting with each other by screwing.

An upper surface of the nut 92 is in contact with a lower surface 83 of the balance-protecting bridge 8, so that the portion 121a of the arm 121 of the connecting member 12 is positioned and fixed in the plane P or substantially in the plane P between the balance bridge 5 and the plate 6 by means of the balance-protecting bridge 8 and the nut 92. In this instance, the portion 121a of the arm 121 is clamped between the balance bridge 5 and the balance-protecting bridge 8, the latter being arranged directly on the nut 92.

The nut 92 preferably also comprises a toothed portion 922 that is intended to interact by meshing with a toothed portion 932 of an adjustment nut 93. This nut comprises a configuration 931, particularly a screw head 931, that is capable of being rotated by a watchmaking tool, such as a screwdriver. Once a screw 91a has been removed, the rotation of the nut 93 thus causes the rotation of the nut 92 about the screw foot 7a, and the translation of said nut 92 in the vertical direction, which makes it possible to generate the vertical or substantially vertical displacement of the first portion 5a of the balance bridge 5, by means of the balance-protecting bridge 8 and the portion 121a of the arm 121 of the connecting member 12, more particularly by means of the first fastening element 13a. The fastening element 13a preferably interacts with the positioning element 7a and/or rests on the nut 92.

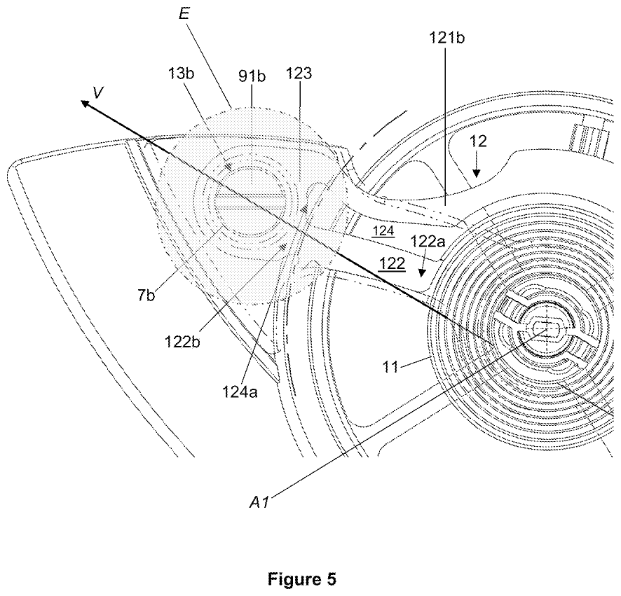

In addition, the second arm 122 of the connecting member 12 is clamped between the first blank 5, in particular the balance bridge 5, and the second blank 6, in particular the plate 6. More specifically, the second arm 122 of the connecting member 12 is clamped between the second portion 5b of the balance bridge 5 and the balance-protecting bridge 8. However, the screw foot 7b does not form an axial play adjustment element. The balance bridge 5, the arm 122 and the balance-protecting bridge 8 are therefore fixed relative to the plate 6, particularly in the vertical direction. The blanks 5, 6 and 8 thus define a fixed connection of the second arm 122, which is fixed relative to the frame of the movement 300. This fixed connection is more particularly defined in the bearing zone schematically delimited by the chain dotted curve E in FIG. 5.

In this embodiment of the assembly device 200, the second portion 121b of the arm 121 is also clamped between the first blank 5, in particular the balance bridge 5, and the second blank 6, in particular the plate 6. More specifically, the second portion 121b of the arm 121 is clamped between the balance bridge 5, in particular the second portion 5b, and the balance-protecting bridge 8. The blanks 5, 6 and 8 thus also define a fixed connection of the second portion 121b of the arm 121, which is fixed relative to the frame of the movement 300. This fixed connection is more particularly defined in the bearing zone schematically delimited by the chain dotted curve E in FIG. 5.

The arm 122 and the second portion 121b of the arm 121 are thus fixed relative to the frame of the movement. They are restrained by the blanks 5, 6, and 8 in the bearing zone schematically delimited by the curve E. In particular, the arm 122 and the second portion 121b of the arm 121 are restrained upstream of the joining zone 123 that connects the arm 122 to the second portion 121b of the arm 121. The arm 122 is thus not affected by any displacement and/or deformation of the arm 121, particularly of the second portion 121b of the arm 121.

In the context of this description, the notions “upstream” and “downstream” are assessed in relation to a vector V (FIGS. 1, 5) that passes through the respective centers of the screw feet 7a, 7b, and therefore the centers of the openings 13a, 13b, and that is oriented from the screw foot 7a toward the screw foot 7b, and therefore from the opening 13a toward the opening 13b. The vector V moves away in particular from the axis A1 toward the screw foot 7b or the opening 13b. The vector V points downstream.

In this particular embodiment of the assembly device 200, the joining zone 123 is located in line with the fastening element 13b of the connecting member 12, which forms one end of the second portion 121b of the arm 121, and one end 122b of the second arm 122. This joining zone 123 at least partially comprises the material the adjoins the longitudinal end 124a of the slot 124. The arm 122 and the second portion 121b of the arm 121 are thus restrained upstream of the longitudinal end 124a of the slot 124 (FIG. 5).

A displacement in the vertical direction of the first portion 121a of the first arm 121 does not therefore have any effect on the second arm 122 and therefore on the blade 11 of the hairspring. The blade 11 is connected to the rest of the hairspring 1 by means of the second arm 122. Such a design therefore makes it possible to preserve the geometric integrity of the blade 11 of the hairspring 1 when adjusting the axial play of the oscillator 100.

Throughout this description, the stiffness of the connecting member 12, particularly the stiffness of the arms 121 and 122, is substantially greater than the stiffness of the blade 11 of the hairspring. In particular,
the overall stiffness of the connecting member 12, particularly of the arms 121 and 122, in bending about an axis contained in the plane P1 and perpendicular to the vector V, is typically at least 10 times greater than the overall stiffness of the blade 11 (bending stress during play adjustment performed by acting on the axial play adjustment elements), and/or
the overall stiffness of the connecting member 12, particularly of the arms 121 and 122, in bending about an axis perpendicular to the plane P1, is typically 1,000 times greater than the overall stiffness of the blade 11.

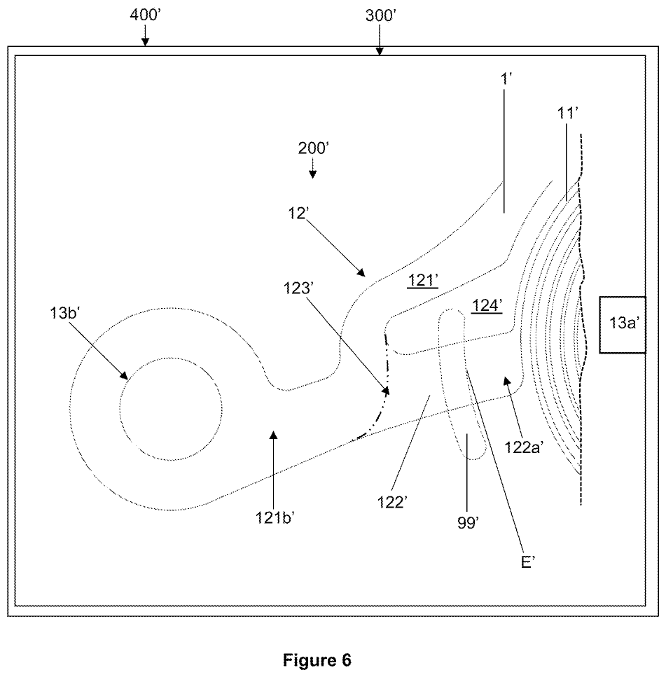

A second embodiment of a timepiece 400′ is described in detail hereinafter with reference to FIG. 6.

The timepiece 400′ is for example a watch, particularly a wristwatch. The timepiece 400′ comprises an assembly or a timepiece movement 300′ suitable for being mounted in a timepiece case in order to protect it from the external environment.

The timepiece movement 300′ can be a mechanical movement, in particular an automatic movement, or a hybrid movement.

In this second embodiment, the reference signs of the elements are based on the reference signs of the elements of the first embodiment that perform an identical or similar function, with the addition of a “′”.

Preferably, the second embodiment differs from the first embodiment solely in the arrangement and/or configuration of the first arm 121′ and the second arm 122′ of the connecting member 12′.

In this second embodiment, the joining zone 123′ for joining the second arm 122′ to the first arm 121′ is located in a different place from the end of the second portion 121b′ of the arm 121′ and the end of the second arm 122′.

By way of example, FIG. 6 schematically illustrates an alternative assembly device 200′ implementing a hairspring 1′ comprising a joining zone 123′ between the second arm 122′ and the first arm 121′ that is located substantially half way between a fastening element 13b′ and the join 122a′ for joining the connecting member 12′ to the blade 11′. In addition, preferably, a rigid retaining plate 99′ fixed to the frame of the timepiece can bear against the second arm 122′, for example in the bearing zone delimited by the curve E′. This plate can contribute to fixing the second arm 122′, and more generally the connecting member 12′, to the frame.

The joining zone 123′ is for example interposed between the retaining plate 99′ and a fastening element 13b′ of the hairspring 1′ that forms one end 121b′ of the first arm 121′, opposite another end of the first arm 121′ that comprises another fastening element.

Whatever the embodiment or variant, it is also possible for the assembly device 200; 200′ to comprise additional elements for adjusting the axial play of the oscillator in the second portion 5b of the balance bridge 5. For example, these additional elements could comprise:
a nut, similar to the nut 92, and
the screw foot 7b.

In particular, the blanks 5, 6 and 8 would then define a fixed connection of the second arm 122; 122′, which is vertically movable relative to the frame of the movement 300; 300′ in the portion 5b.

Whatever the embodiment or variant, in a simplified version of the solution, it is also possible to eliminate the balance-protecting bridge 8. The surface 111 of the connecting member 12 can then press directly on the nut 92.

Whatever the embodiment or variant, it is also possible to replace the screw feet 7a, 7b with pins, it being possible for the balance bridge and the balance-protecting bridge, if present, to be fastened with screws passing through them and screwed directly into the plate.

Whatever the embodiment or variant, the ratio of the length of the first arm to the length of the second arm is advantageously between 2 and 10 or between 3 and 8.

Whatever the embodiment or variant, the joining zone 123; 123′ for joining the first arm 121; 121′ to the second arm 122; 122′ is advantageously located at a point or boundary such that the ratio of:
the distance separating this point or boundary from the first fastening element 13a; 13a′ to
the distance separating this point or boundary from the second fastening element 13b; 13b′ is greater than 4 or greater than 8.

In the embodiments shown in FIGS. 1 to 6, the hairspring is a single piece. In other words, the blade 11, the connecting member 12 and the collet 14 are integrally formed. However, as an alternative, whatever the embodiment or variant, the hairspring can be the result of an assembly, it being possible for the connecting member 12 to be attached to the blade 11 for example.

In the embodiments shown, the hairspring can fully or partially comprise:
single-crystal silicon whatever its orientation,
polycrystalline silicon,
amorphous silicon,
amorphous silicon dioxide,
doped silicon whatever the type and level of doping, or porous silicon,
silicon carbide,
glass,
technical ceramic, or
quartz.

As an alternative, the hairspring can be manufactured from metal or a metal alloy, particularly an Nb—Zr alloy.

Throughout this application, “arm” is given to mean a form having a length, a width and a thickness, the length being at least two times greater than the greatest of the other dimensions (width and thickness). The length is measured along a non-straight curve if applicable, if the form extends along this non-straight curve.

The solutions described above have specific hairspring configurations, which make it possible to preserve the geometric integrity of the blade of said hairspring when adjusting the axial play of the oscillator. Such a configuration is particularly suitable when the oscillator is assembled by means of an assembly device in which the outer end of the hairspring, particularly a connecting member rigidly connected to the blade of the hairspring, is capable of being actuated by axial play adjustment elements.

The solutions described above thus have hairspring configurations that allow the optimum implementation of the assembly device provided with axial play adjustment elements.

In other words, the solutions described above are based on a hairspring provided with a connecting member that has the specific feature of comprising two separate arms each having a stiffness substantially greater than the stiffness of the blade of the hairspring, a first portion of a first arm being capable of being moved in a vertical or substantially vertical direction, and a non-movable second arm connecting the outer end of the blade of said hairspring to a second portion of the first arm. Such a hairspring is advantageously intended to be incorporated into an assembly device of an oscillator that is intended to restrain at least the second arm, in particular upstream of the joining zone for joining the second arm to the second portion of the first arm, and that comprises axial play adjustment elements capable of acting on the first portion of the first arm.

1. A hairspring comprising a spring blade and a connecting member for fastening the hairspring to a frame, the connecting member comprising:
a first fastening element,
a second fastening element,
a first arm connecting the first fastening element to the second fastening element, and
a second arm connecting the first arm to the spring blade, the second arm being connected to the spring blade in a first joining zone,
the hairspring being configured and/or arranged so that a first displacement of a first amplitude of the first fastening element relative to the second fastening element does not cause any displacement of the second arm, or causes a second displacement of a second amplitude of the second arm, relative to the second fastening element, the second amplitude being less than 0.15 times the first amplitude.

2. The hairspring as claimed in claim 1, wherein the first amplitude and the second amplitude are measured perpendicular to:
a first plane in which the spring blade extends, and/or
a second plane in which the connecting member extends.

3. The hairspring as claimed in claim 1, wherein a ratio of a length of the first arm to a length of the second arm is in a range of from 2 to 10.

4. The hairspring as claimed in claim 1, wherein a second joining zone for joining the first arm to the second arm is located at a point or boundary wherein ratio of:
a distance separating the point or boundary from the first fastening element to
a distance separating the point or boundary from the second fastening element
is greater than 4.

5. The hairspring as claimed in claim 1, wherein the hairspring is a single piece or integrally formed.

6. The hairspring as claimed in claim 1, wherein the hairspring is partially or fully made from:
single-crystal silicon whatever its orientation, or
polycrystalline silicon, or
amorphous silicon, or
amorphous silicon dioxide, or
doped silicon whatever the type and level of doping, or
porous silicon, or
silicon carbide, or
glass, or
ceramic, or
quartz, or
metal, or
a metal alloy, particularly an Nb—Zr alloy.

7. An assembly, for a timepiece movement, comprising:
an oscillator comprising:
a balance, and
a hairspring as claimed in claim 1, mounted on a staff, and
an assembly device comprising:
a first blank for pivoting the oscillator, and
a second blank for pivoting the oscillator.

8. The assembly as claimed in claim 7, wherein the assembly device comprises a first element for positioning the first blank relative to the second blank, the first positioning element being arranged and/or configured so as to position the hairspring relative to the first blank and/or relative to the second blank, in a plane of the assembly.

9. The assembly as claimed in claim 7, wherein the assembly device comprises a first axial play adjustment element and a second axial play adjustment element, the first axial play adjustment element interacting with the second axial play adjustment element to adjust the axial play of the oscillator by moving the first fastening element relative to the first blank for pivoting the oscillator, and/or the second blank for pivoting the oscillator.

10. The assembly as claimed in claim 9, wherein the first axial play adjustment element comprises a nut and the second axial play adjustment element comprises a thread made on a first element for positioning the first blank relative to the second blank.

11. The assembly as claimed in claim 7, wherein the first blank and the second blank are arranged and/or configured to hold the hairspring between the first and second blanks.

12. The assembly as claimed in claim 7, wherein the second arm is held interposed or clamped between:
the first blank, and
the second blank or a retaining element,
or between:
the second blank, and
a retaining element.

13. The assembly as claimed in claim 7, wherein the second joining zone for joining the first arm to the second arm is held, in particular held interposed or clamped, between the first blank and the second blank.

14. The assembly as claimed in claim 7, wherein:
the first blank is a balance bridge, and/or
the second blank is a plate.

15. A timepiece comprising the hairspring as claimed in claim 1.

16. The hairspring as claimed in claim 1, wherein the hairspring is configured and/or arranged so that the first displacement of the first amplitude of the first fastening element relative to the second fastening element does not cause any displacement of the first joining zone, or causes a second displacement of a second amplitude of the first joining zone, relative to the second fastening element.

17. The hairspring as claimed in claim 1, wherein the second amplitude is less than 0.1 times the first amplitude.

18. The hairspring as claimed in claim 1, wherein the second amplitude is less than 0.05 times the first amplitude.

19. The hairspring as claimed in claim 3, wherein the ratio of the length of the first arm to the length of the second arm is in a range of from 3 to 8.

20. The hairspring as claimed in claim 4, wherein the ratio of:
the distance separating the point or boundary from the first fastening element to
the distance separating the point or boundary from the second fastening element is greater than 8.
